(19) United States
(12) Patent Application Publication
(10) Pub. No.: US 2007/0116452 A1
(43) Pub. Date: May 24, 2007

(54) Camera module not allowing foreign matter to enter its optical system

(75) Inventors: Masaru Aoki, Fukushima-ken (JP); Seiichi Nagai, Fukushima-ken (JP)

Correspondence Address: BEYER WEAVER LLP, P.O. BOX 70250, OAKLAND, CA, 94612-0250, US

(73) Assignee: ALPS ELECTRIC CO., LTD.

(21) Appl. No.: 11/523,311

(22) Filed: Sep. 18, 2006

(30) Foreign Application Priority Data
Nov. 21, 2005 (JP) 2005-335391

(51) Int. Cl. G03B 3/00

(52) U.S. Cl. 396/144

(57) ABSTRACT

A camera module includes a lens barrel holding a lens, and a main body holding the lens barrel, the lens barrel being capable of moving relative to the main body in the direction of the optical axis of the lens. The lens barrel has a protuberance on the underside thereof throughout the circumferential direction. The main body has a recess at a position corresponding to the protuberance of the lens barrel throughout the circumferential direction, the recess accommodating the protuberance. The protuberance is formed so as to have a height such that the protuberance is disposed in the recess both before and after the movement of the lens barrel relative to the main body in the direction of the optical axis of the lens.

### BACKGROUND OF THE INVENTION

1. Field of the Invention

The present invention relates to a camera module in which a lens barrel holding a lens is vertically movable relative to a main body, and more specifically, it relates to a camera module configured so that its optical system is not affected by foreign matter generated by the rubbing of the lens barrel against the main body when the lens barrel moves vertically.

2. Description of the Related Art

Hitherto, a camera module switchable between a normal photographing mode and a macro photographing mode has been known. In such a camera module, in order to perform focus adjustment according to mode switching, a lens barrel holding a lens is held in a fixed main body. The lens barrel is moved relative to the main body in the direction of the optical axis of the lens, thereby changing the distance between the lens and an image sensor disposed in the main body. Thus, switching between a normal photographing position and a macro photographing position can be performed. Such a camera module is disclosed in, for example, Japanese Unexamined Patent Application Publication No. 2003-337279.

The lens barrel slides with the outer peripheral surface in contact with the inner peripheral surface of the main body so as to prevent foreign matter from entering an optical system held in the lens barrel. However, if the lens barrel is repeatedly moved relative to the main body, foreign matter can be generated by abrasion of the outer peripheral surface of the lens barrel and the inner peripheral surface of the main body. If such foreign matter generated between the main body and the lens barrel enter the optical system, the foreign matter can affect the image obtained in the image sensor.

### SUMMARY OF THE INVENTION

The present invention is made in consideration of the above problem. It is an object of the present invention to provide a camera module not allowing foreign matter generated by the sliding of the lens barrel relative to the main body to enter the optical system.

To solve the above problem, in an aspect of the present invention, a camera module includes a lens barrel holding a lens, and a main body holding the lens barrel, the lens barrel being capable of moving relative to the main body in the direction of the optical axis of the lens. The lens barrel has a protuberance on the underside thereof throughout the circumferential direction. The main body has a recess at a position corresponding to the protuberance of the lens barrel throughout the circumferential direction, the recess accommodating the protuberance. The protuberance is formed so as to have a height such that the protuberance is disposed in the recess both before and after the movement of the lens barrel relative to the main body in the direction of the optical axis of the lens. Therefore, foreign matter generated by movement of the lens barrel relative to the main body can be prevented from entering the inner peripheral side where an optical system is disposed.

In another aspect of the present invention, a camera module includes a lens barrel holding a lens, and a main body holding the lens barrel, the lens barrel being capable of moving relative to the main body in the direction of the optical axis of the lens. The lens barrel has a recess in the underside thereof throughout the circumferential direction. The main body has a protuberance at a position corresponding to the recess of the lens barrel throughout the circumferential direction, the protuberance being accommodated by the recess. The protuberance is formed so as to have a height such that the protuberance is disposed in the recess both before and after the movement of the lens barrel relative to the main body in the direction of the optical axis of the lens. Therefore, foreign matter generated by movement of the lens barrel relative to the main body can be prevented from entering the inner peripheral side where an optical system is disposed.

The protuberance and the recess may face each other with a slight gap between their sides. In this case, friction does not occur between the protuberance and the recess, and generation of foreign matter can be prevented.

### BRIEF DESCRIPTION OF THE DRAWINGS

FIG. 1 is an exploded perspective view of a camera module in an embodiment;

FIG. 2 is a perspective view showing a main body with a lens barrel attached thereto; and

FIG. 3 is a sectional view of the camera module.

### DESCRIPTION OF THE PREFERRED EMBODIMENTS

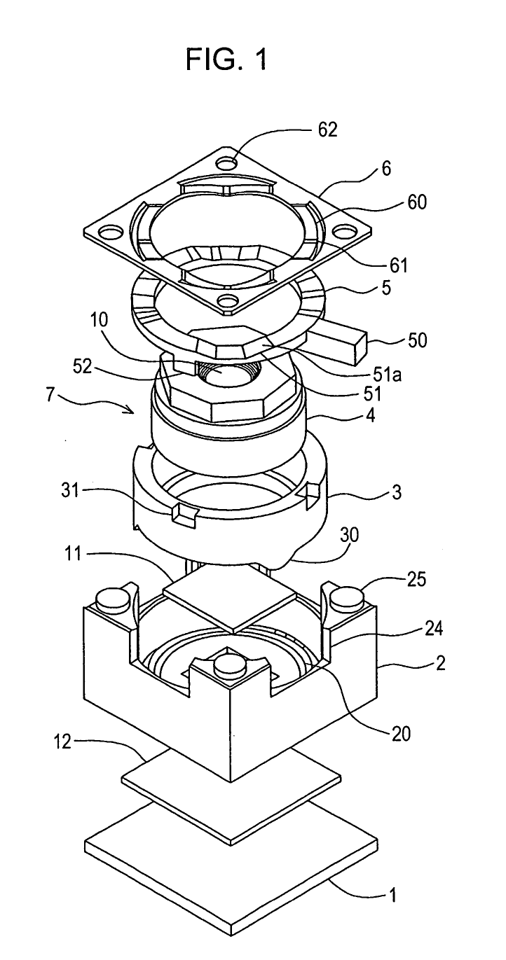

A first embodiment of the present invention will now be described with reference to the drawings in detail. FIG. 1 is an exploded perspective view of a camera module in this embodiment. As shown, the camera module in this embodiment includes a flat substrate 1 and a hollow main body 2 disposed thereon. The main body 2 rotatably holds a lens barrel 7 therein. The lens barrel 7 includes a cam member 3, a lens barrel main body 4, and a lever member 5. On the top of the main body 2, an elastic plate 6 is provided.

On the top of the substrate 1, an image sensor 12 is disposed. The image sensor 12 includes a two-dimensional array of photoelectric transducers. The image sensor 12 receives light from a photographic subject through an optical system of the camera module and outputs image data. On the underside of the main body 2, a filter 11 is disposed. The filter 11 is a so-called IR filter and is provided for removing infrared light from the light from the optical system.

The outer periphery on the bottom of the main body 2 has a raised outer peripheral rail surface 20 formed along the circumferential direction. Protrusions 30 formed on the underside of the lens barrel 7 are in contact with the outer peripheral rail surface 20. Outer peripheral walls of the main body 2 have openings 24 formed therein. Through one of the openings 24, a switching lever 50 provided in the lens barrel 7 protrudes outward. The openings 24 are horizontally long so that the switching lever 50 can be operated horizontally.

The cam member 3, which constitutes the lens barrel 7, is hollow cylindrical and, as mentioned above, has protrusions 30 on the underside. The lower ends of the protrusions 30 are in contact with the outer peripheral rail surface 20 of the main body 2 and move along the outer peripheral rail surface 20 when the lens barrel 7 rotates relative to the main body 2. The cam member 3 has four cutout-like engaged portions 31 formed in the top thereof in the circumferential direction. The engaged portions 31 engage with engaging portions 52 of the lever member 5.

The lens barrel main body 4 holds lenses 10 and is fitted into and fixed to the cam member 3. The lever member 5 is generally ring-shaped and has the switching lever 50 outwardly protruding from the peripheral surface. In addition, the lever member 5 has a plurality of lens-barrel different-in-level portions 51 formed in the top thereof. Moreover, as mentioned above, the lever member 5 has engaging portions 52 formed on the underside thereof. The engaging portions 52 engage with the engaged portions 31 formed in the top of the cam member 3, and thereby the lever member 5 is fixed to the cam member 3.

The elastic plate 6 is formed of metal and has a circular cutout in the center. Around the circular cutout, four concentric circular-arc-shaped cutouts are formed along the circumferential direction, and thereby elastic narrow spring portions 60 are formed. Every spring portion 60 is bent downward and is lowest at the middle, which forms a pressing portion 61. The pressing portion 61 presses the top of the lever member 5, which constitutes the lens barrel 7, so as to urge the lens barrel 7 downward. The elastic plate 6 has fixing holes 62 formed in four corners thereof. The main body 2 has elastic-plate fixing portions 25 formed on the top thereof. The elastic-plate fixing portions 25 are fitted in the fixing holes 62, and thereby the elastic plate 6 is fixed to the main body 2.

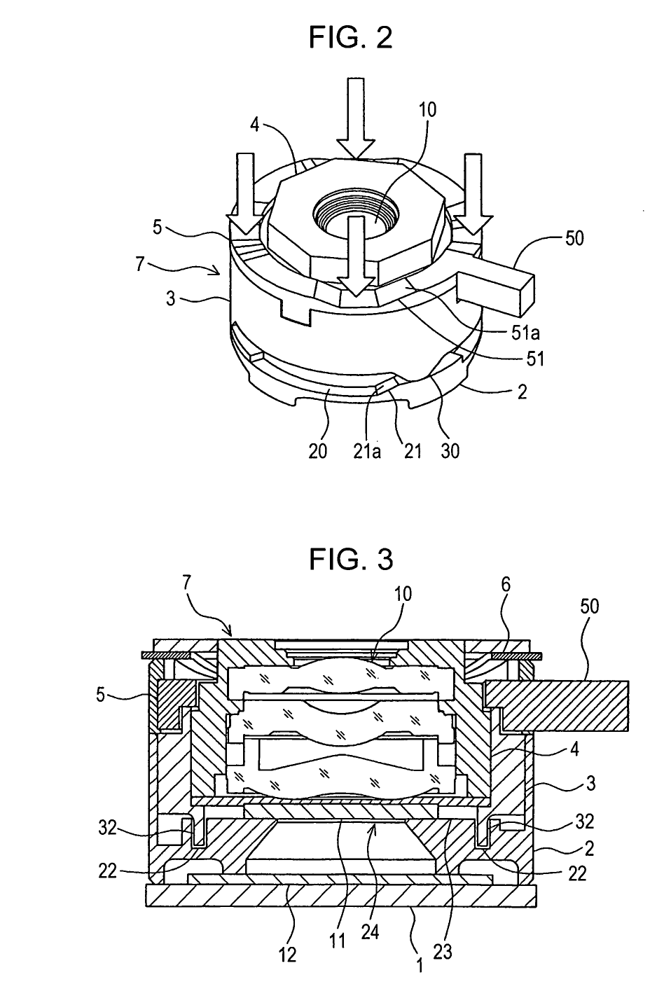

FIG. 2 is a perspective view showing the main body 2 with the lens barrel 7 attached thereto. In this figure, the walls of the main body 2 are omitted. As described above, the main body 2 has an outer peripheral rail surface 20 formed on the bottom thereof along the circumferential direction. The outer peripheral rail surface 20 includes main-body different-in-level portions 21, each including an upper level, a lower level, and a sloping surface 21a therebetween.

The protrusions 30 of the lens barrel 7 in contact with the outer peripheral rail surface 20 move between the upper level and the lower level along the main-body different-in-level portions 21 with the rotation of the lens barrel 7 by operating the switching lever 50. The lens barrel 7 thereby moves vertically and changes the distance between the lens 10 held in the lens barrel main body 4 and the image sensor 12 disposed in the main body 2, thereby switching between the normal photographing mode and the macro photographing mode.

As described above, the lens barrel 7 is urged by the pressing portions 61 of the elastic plate 6, at a plurality of places on the top thereof, and has lens-barrel different-in-level portions 51. The lens-barrel different-in-level portions 51 are disposed so as to be urged by the pressing portions 61 when the protrusions 30 are in contact with the upper levels of the main-body different-in-level portions 21. Each lens-barrel different-in-level portion 51 includes a lower level between upper levels, and sloping surfaces 51a between the lower level and the upper levels.

In FIG. 2, the protrusions 30 of the lens barrel 7 are disposed on the upper levels of the outer peripheral rail surface 20. In this state, the pressing portions 61 of the spring portions 60 press the lower levels in the top of the lens barrel 7 as shown by arrows in the figure. When the lens barrel 7 is rotated by operating the switching lever 50, the protrusions 30 move onto the lower levels of the outer peripheral rail surface 20 via the sloping surfaces 21a of the main-body different-in-level portions 21. Accordingly, the lens barrel 7 moves downward. At the same time, the pressing portions 61 move onto the upper levels via the sloping surfaces 51a of the lens-barrel different-in-level portions 51. When, from this state, the lens barrel 7 is rotated in the reverse direction by operating the switching lever 50, the same operation is performed in the reverse direction. That is to say, the lens barrel 7 moves upward, and the pressing portions 61 move onto the lower levels.

As described above, the pressing portions 61 of the spring portions 60 move between the upper levels and the lower levels of the lens-barrel different-in-level portions 51 with the vertical movement of the lens barrel 7. Since the position of the pressing portions 61 in the vertical direction is fixed and therefore the vertical movement of the lens barrel 7 does not cause displacement of the spring portions 60, it is possible to prevent deterioration of the spring portions 60 and to extend the life of the spring portions 60.

FIG. 3 is a sectional view of the camera module. As shown, the lens barrel main body 4, which constitutes the lens barrel 7, holds a lens 10 therein. The lens 10 includes three lens elements. The main body 2 has an inward protruding mount portion 23 formed around the inner periphery thereof below the lens barrel 7. On this mount portion 23, the periphery of the filter 11 is disposed.

The cam member 3, which constitutes the lens barrel 7, has a downward protruding protuberance 32 formed at the lower end thereof throughout the circumferential direction. On the other hand, the mount portion 23 of the main body 2 has a recess 22 formed in the outer periphery thereof throughout the circumferential direction. In the recess 22, the protuberance 32 of the lens barrel 7 is inserted. The width of the recess 22 is slightly larger than the width of the protuberance 32, and the sides of the recess 22 and the protuberance 32 face each other with a slight gap therebetween.

The length by which the protuberance 32 is inserted in the recess 22 is larger than the stroke of the vertical movement of the lens barrel 7. In FIG. 3, the lens barrel 7 is at the lower position, and the lower end of the protuberance 32 is close to the bottom of the recess 22. When the lens barrel 7 is at the upper position, the lower end of the protuberance 32 remains in the recess 22.

As described above, a protuberance 32 is provided on the inner periphery of the lower end of the lens barrel 7, a recess 22 to accommodate the protuberance 32 is provided in the main body 2, and the protuberance 32 is disposed in the recess 22 both before and after the vertical movement of the lens barrel 7. Therefore, if foreign matter such as abrasion dust is generated by the sliding of the lens barrel 7 relative to the main body 2, it is hard for the foreign matter to enter the area where the filter 11 and the image sensor 12 are disposed. Therefore, the image obtained in the image sensor 12 is not affected. In addition, the recess 22 and the protuberance 32 are formed so that the sides of the recess 22 and the protuberance 32 face each other with a slight gap therebetween. Therefore, it is harder for the foreign matter generated on the outer periphery side of the lens barrel 7 to enter the inside.

In this embodiment, a protuberance 32 is provided on the underside of the lens barrel 7, and a recess 22 is provided in the main body 2. Alternatively, it is possible to provide a protuberance in the main body 2 and to provide a recess in the underside of the lens barrel 7. Also in this case, whether the lens barrel 7 is at the upper or lower position, the protuberance is in the recess. Therefore, although the lens barrel 7 moves vertically, it is harder for the foreign matter generated on the outer periphery side of the lens barrel 7 to enter the inside.

Although embodiments of the present invention have been described above, it is to be understood that the present invention is not intended to be limited to these embodiments, and various changes may be made therein without departing from the scope of the technical idea of the present invention.

What is claimed is:

1. A camera module comprising:
a lens barrel holding a lens; and
a main body holding the lens barrel,
the lens barrel being capable of moving relative to the main body in the direction of the optical axis of the lens,
wherein the lens barrel has a protuberance on the underside thereof throughout the circumferential direction,
the main body has a recess at a position corresponding to the protuberance of the lens barrel throughout the circumferential direction, the recess accommodating the protuberance, and
the protuberance is formed so as to have a height such that the protuberance is disposed in the recess both before and after the movement of the lens barrel relative to the main body in the direction of the optical axis of the lens.

2. A camera module comprising:
a lens barrel holding a lens; and
a main body holding the lens barrel,
the lens barrel being capable of moving relative to the main body in the direction of the optical axis of the lens,
wherein the lens barrel has a recess in the underside thereof throughout the circumferential direction,
the main body has a protuberance at a position corresponding to the recess of the lens barrel throughout the circumferential direction, the protuberance being accommodated by the recess, and
the protuberance is formed so as to have a height such that the protuberance is disposed in the recess both before and after the movement of the lens barrel relative to the main body in the direction of the optical axis of the lens.

3. The camera module according to claim 1, wherein the protuberance and the recess face each other with a slight gap between their sides.
